(19) United States
(12) Patent Application Publication
(10) Pub. No.: US 2022/0269647 A1
(43) Pub. Date: Aug. 25, 2022

(54) COMMUNICATIONS SURVEILLANCE PLATFORMS

(71) Applicant: Txtsmarter, Inc., San Mateo, CA (US)

(72) Inventors: Nuri Otus, San Mateo, CA (US); Alexander Otus, San Mateo, CA (US); Sabine Zimmerhansl, San Mateo, CA (US)

(21) Appl. No.: 17/668,309

(22) Filed: Feb. 9, 2022

(51) Int. Cl. G06F 16/11; H04W 4/14; H04L 51/52; H04L 51/216; H04L 51/224

(52) U.S. Cl. CPC G06F 16/113; H04W 4/14; H04L 51/52; H04L 51/216; H04L 51/224; G06F 16/116; G06F 40/279

(57) ABSTRACT

Described herein are examples of communications surveillance platforms. A communications surveillance platform may receive a message. The message may have been communicated using a private messaging channel operating on a user device. The private messaging channel may be monitored by a private messaging channel interface of a client archiving application configured to send the message to the processor via the network interface. The message may be sent or received by a user of the user device. The message may be a short message system message, a multimedia message system message, an end-to-end message, an over-the-top message, or a social media direct message. The communications surveillance platform may archive the message on an electronic data storage unit in a searchable format.

### BACKGROUND

In recent years, the proliferation of devices such as mobile phones and tablet computers have driven a shift to private messaging on many platforms including via the Short Messaging Service (SMS) protocol, the Multimedia Messaging Service (MMS) protocol, WHATSAPP®, WECHAT®, IMESSAGE®, ANDROID® MESSENGER and SLACK®, and many social communications platforms as a popular way of communication both for personal and business communications, replacing and/or augmenting traditional communications sent via email. Private messaging application and platforms are defined as a message stream such as SMS/MMS, social messaging platforms, stand-alone messaging platforms, and similar tools, shared between a finite, unchangeable group of participants.

The environment of business messaging is facing increasing regulations and oversight, for example, by the FINRA, SEC, FDIC, FCA, FRCP, MiFID II, HIPAA, GDPR or other privacy organizations and regulations and many others. Such regulations may require complete, auditable records of messages to be available, as well as to protect the contents of such messages. Failure to comply with such requirements may expose businesses in highly regulated industries and occupations (e.g., human resources, finance, law, health, insurance, sports, or technology) to sanctions, fines, adverse press, potential data breaches, customer ire, reputational risk, and/or other business losses. Furthermore, companies may risk exposure to liabilities from messaging by employees. Companies may have needs or requirements to oversee messaging.

### BRIEF DESCRIPTION OF THE DRAWINGS

The present description will be understood more fully when viewed in conjunction with the accompanying drawings of various examples of communications surveillance platforms. The description is not meant to limit the communications surveillance platforms to the specific examples. Rather, the specific examples depicted and described are provided for explanation and understanding of communications surveillance platforms. Throughout the description the drawings may be referred to as drawings, figures, and/or FIGs.

FIG. 1 illustrates a message archival system, according to an embodiment.

FIG. 2 illustrates a device schematic for various devices used in the message archival system, according to an embodiment.

FIG. 3 illustrates a message archival system, according to an embodiment.

FIG. 4 illustrates a method of operating a communications surveillance platform, according to an embodiment.

FIG. 5 illustrates a method of operating a communications surveillance platform, according to an embodiment.

FIG. 6 illustrates an example report, according to an embodiment.

FIG. 7 illustrates an example system, according to an embodiment.

### DETAILED DESCRIPTION

Communications surveillance platforms (e.g., private messaging platforms) as disclosed herein will become better understood through a review of the following detailed description in conjunction with the figures. The detailed description and figures provide merely examples of the various embodiments of communications surveillance platforms. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

In recent years, the proliferation of devices such as mobile phones and tablet computers have driven a shift to private messaging and social communications platforms as a popular way of communication both for personal and business communications, replacing and/or augmenting traditional communications sent via email. Private messaging applications and platforms may include a message stream such as short message system (SMS) protocols, or a multimedia messaging system (MMS) protocols, social messaging platforms, stand-alone messaging platforms, and similar tools, shared between a finite, unchangeable group of participants.

A conventional communications surveillance platform or private messaging platform may include a system for archiving communications via communications channels hosted by a business. For example, a conventional communications surveillance platform may archive emails and messages sent and received, provided a secondary number protocol or secondary user account is utilized. A secondary number protocol may refer to a second phone number assigned to a device or person, limiting access to only those messages utilizing the non-primary (e.g., secondary) number. However, use of secondary number protocol may run a risk of data gaps, data loss, and potential associated sanctions. Such conventional archivers or private messaging platforms may be implemented for industry and/or regulatory compliance purposes.

However, conventional communications surveillance platforms are limited in reach. For example, conventional communications surveillance platforms may be unable to archive messages in private messaging channels (PMCs), including, inter alia, private messaging applications, services, and platforms. PMCs may include, for example, text messaging systems (e.g., for an SMS message, or an MMS message), an end-to-end messaging system (e.g., IMESSAGE®, WHATSAPP®, ANDROID® MESSENGER, or WECHAT®/WECOM®), or a social media messaging system (e.g., direct messages, FACEBOOK® MESSENGER, TWITTER®, LINKEDIN® messenger, or other social media messaging systems or protocols, etc.). For such PMCs, conventional communications surveillance platforms do not provide for regulatory compliance, data gap prevention, support for “clean” and comprehensive audits, integration with existing platforms, or secure archiving of all message data. Further, conventional communications surveillance platforms may require business users or the business's clients to change their behavior (e.g., a person may be required to use a specific messaging application for compliance purposes, rather than the user's or their client's preferred PMCs). Embodiments may collect, inter alia, Unicode expressions and non-Latin/script characters.

Implementations of communications surveillance platforms or private messaging platforms may address some or all of the problems described above. Communications surveillance platforms or private messaging platforms may include a software-as-a-service (SaaS), platform-as-a-service (PaaS), and/or infrastructure-as-a-service (IaaS) solution that may collect, verify, encrypt, and archive PMC messaging in real time to mitigate inherent data compliance risks. A communications surveillance platform or private messaging platforms may receive, analyze, and archive a message. The message may have been communicated using a PMC operating on the user device. The PMC may be monitored by a PMC interface of a client archiving application configured to send the message to the processor via the network interface. The message may be a short message system message, a multimedia message system message, an end-to-end message, an over-the-top message, or a social media direct message.

Communications surveillance platforms may capture non-oral, non-character-based, and multimedia communications in real time, providing a turn-key enterprise solution with seamless installation over mobile, and may be platform-agnostic across platforms implementing various PMCs. Communications surveillance platforms may be a device-driven solution requiring no interaction from users to execute an archival operation, capture mobile data in an encrypted fashion, and index data and make available for fast, on-demand search (e.g., including full, uninterrupted threads, which may include time and date stamps and other contextual information) over all supported PMCs. Images, files, and custom content controlled via a software development kit (SDK) over a secure application programming interface (API) may be captured in an interpreted format and in their original format. Once deployed, a business user can utilize their chosen PMCs as they normally would. The communications surveillance platform may operate in the background (e.g., unobtrusively), to provide compliance for communications over various PMCs.

The communications surveillance platform may present a unified interface for regulatory compliance, content indexing, supervision, auditing, electronic document discovery, and litigation. Data may be captured (e.g., transferred and stored) in compliance with the GDPR, the CCPA, and other state, national, or international privacy laws and regulations applicable to users and residents of the respective geographies.

Using the communications surveillance platform, the data from PMCs may be made available, for example, for compliance, legal, regulatory, and other purposes. A business may have sole control and visibility over the archived data.

Communications surveillance platforms may be integrated with existing compliance and risk platforms and processes including, but not limited to, existing electronic/email communications monitoring, advertising monitoring, investigation, FCPA, and e-discovery systems, etc., for example using an API or other custom integration.

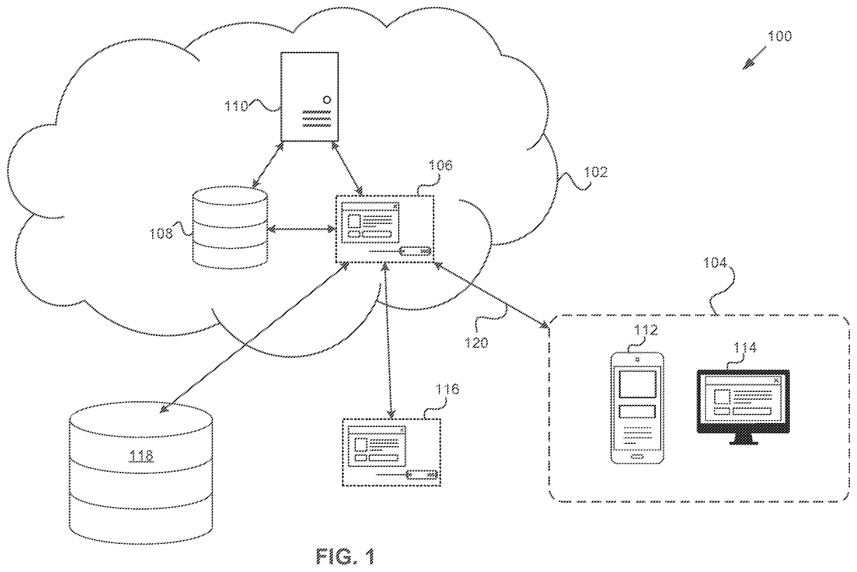

FIG. 1 illustrates a message archival system 100, according to an embodiment. The message archival system 100 includes internal and external data resources for managing a project. The message archival system 100 may result in reduced memory allocation at client devices and may conserve memory resources for application servers.

The message archival system 100 may include a cloud-based data management system 102 and a user device 104. The cloud-based data management system 102 may include an application server 106, a database 108, and a data server 110. The user device 104 may include one or more devices associated with user profiles of the message archival system 100, such as a smartphone 112 and/or a personal computer 114. The message archival system 100 may include external resources such as an external application server 116 and/or an external database 118. The various elements of the message archival system 100 may communicate via various communication links 120. An external resource may generally be considered a data resource owned and/or operated by an entity other than an entity that utilizes the cloud-based data management system 102 and/or the user device 104.

The message archival system 100 may be web-based. The user device 104 may access the cloud-based data management system 102 via an online portal set up and/or managed by the application server 106. The message archival system 100 may be implemented using a public internet. The message archival system 100 may be implemented using a private intranet. Elements of the message archival system 100, such as the database 108 and/or the data server 110, may be physically housed at a location remote from an entity that owns and/or operates the message archival system 100. For example, various elements of the message archival system 100 may be physically housed at a public service provider such as a web services provider. Elements of the message archival system 100 may be physically housed at a private location, such as at a location occupied by the entity that owns and/or operates the message archival system 100.

The communication links 120 may be direct or indirect. A direct link may include a link between two devices where information is communicated from one device to the other without passing through an intermediary. For example, the direct link may include a Bluetooth™ connection, a Zigbee connection, a WiFi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 120, may refer to any of the aforementioned indirect communication links.

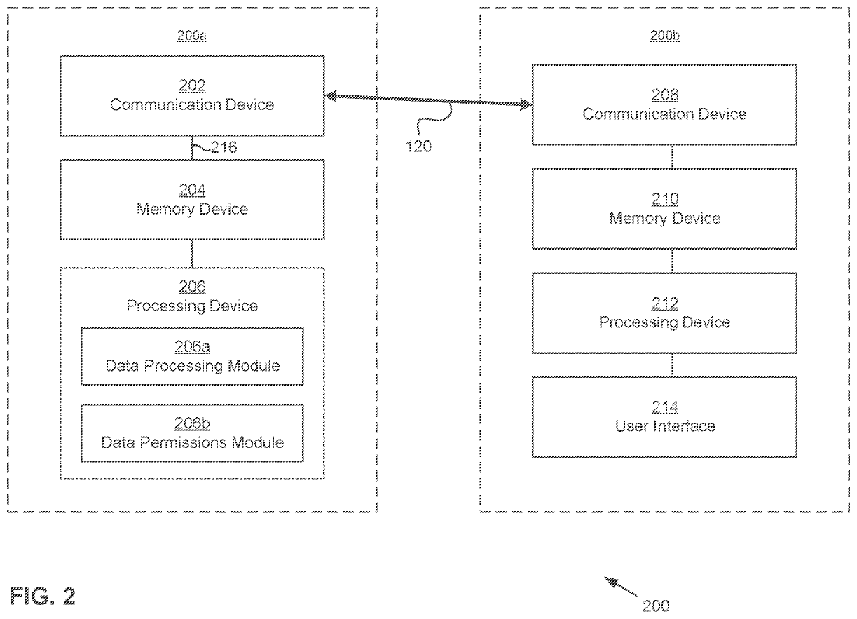

FIG. 2 illustrates a device schematic 200 for various devices used in the message archival system 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200a. The data processing module 206a may cause data to be written and stored in the memory device 204 based on the inputs from the client device 200b. The data processing module 206a may receive data stored in the memory device 204 and output the data to the client device 200a via the communication device 202. The data permissions module 206b may determine, based on permissions data stored in the memory device, what data to output to the client device 200b and what format to output the data in (e.g., as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the personal computer 114. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the message archival system 100. Various of the elements of the message archival system 100 may include data storage and/or processing capabilities. Such capabilities may be rendered by various electronics for processing and/or storing electronic signals. One or more of the devices in the message archival system 100 may include a processing device. For example, the cloud-based data management system 102, the user device 104, the smartphone 112, the personal computer 114, the external application server 116, and/or the external database 118 may include a processing device. One or more of the devices in the message archival system 100 may include a memory device. For example, the cloud-based data management system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the message archival system 100. Such memory allocation may be based on instructions stored in the memory device. Memory resources at a specific device may be conserved relative to other systems that do not associate variables and other object with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the message archival system 100 may include data communication capabilities. Such capabilities may be rendered by various electronics for transmitting and/or receiving electronic and/or electromagnetic signals. One or more of the devices in the message archival system 100 may include a communication device, e.g., the communication device 202 and/or the communication device 208. For example, the cloud-based data management system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a WiFi and/or cellular network. As used herein, “communication device” “communication component,” and/or “communication unit” may be used generically herein to refer to any or all of the aforementioned elements and/or features of the communication component.

Various of the elements in the message archival system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the message archival system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the data analysis system 100 and/or various elements of the data analysis system described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the data analysis system 100.

Various electronic communications between different components of systems embodied herein may be encrypted, for example using transport layer security (TLS) or secure socket layer (SSL) encryption.

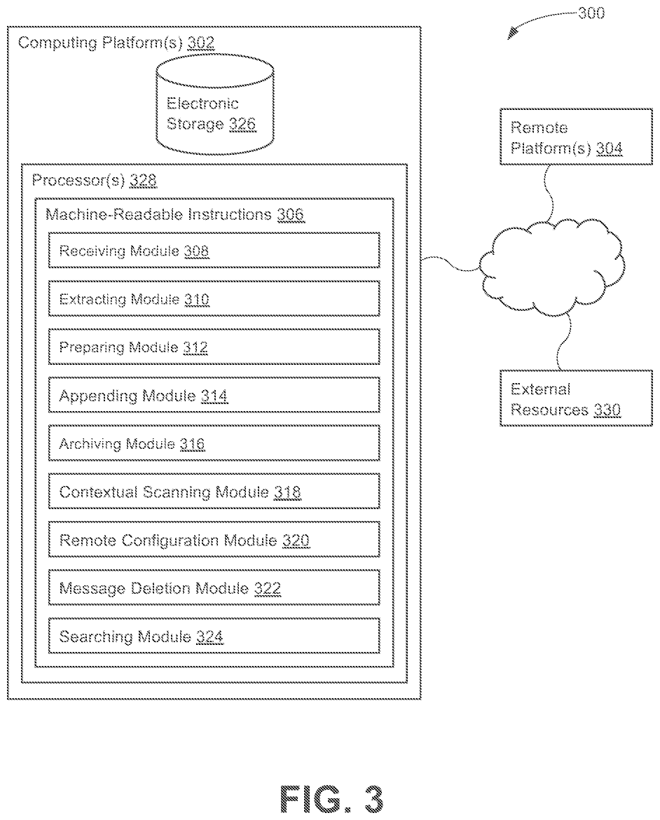

FIG. 3 illustrates a message archival system 300, according to an embodiment. The system 300 may provide for hardware for the implementation of embodiments as described herein.

In some embodiments, the system 300 may include one or more computing platforms 302, which may be similar to, for example, one or more of the cloud-based user management system 102, the application server, the data server 110, or the server device 200a. The computing platform(s) 302 may communicate with one or more remote platforms 304, which may be similar to one or more of the user device 104 or the client device 200b, according to a client/server architecture, a peer-to-peer architecture, and/or other architectures. The remote platform(s) 304 may communicate with other remote platforms via computing platform(s) 302 and/or according to a client/server architecture, a peer-to-peer architecture, and/or other architectures. Users may access the system 300 via remote platform(s) 304.

The computing platform(s) 302 may be configured by machine-readable instructions 306. The machine-readable instructions 306 may include one or more instruction modules. The instruction modules may include computer program modules. The instruction modules may include one or more of the modules 308, 310, 312, 314, 316, 318, 320, 322, or 324 and/or other instruction modules.

A receiving module 308 may receive a message from a user device via a network interface. The user/client device may be a mobile device, a tablet, or a computer. The message may have been communicated using a PMC operating on a user/client device. The PMC may be monitored by a PMC interface of a client archiving application configured to send the message to the processor via the network interface. The message may have been sent or received by a user of the user device. The message may be a short message system message, a multimedia message system message, an end-to-end message, an over-the-top message, or a social media direct message.

The user device may be a registered user device. The registration of the user device may include an account for the user device and provisioning for the account. The provisioning may include a configuration of an internet location of a relay pipeline, direct data store locations for media contained in messages, REST API service locations, encryption requirements around stored data, backup requirements and options, encryption keys, information required by a data privacy law or a legal agreement, a location of the archiving servers over an internet protocol network, and/or credentials required to access the archiving server and upload data to the archiving server.

The message may be encrypted by the PMC interface into an encrypted message format, the message may be received at the processor in the encrypted message format, and the remote archiving application may be configured to decrypt the message from the encrypted message format.

An extracting module 310 may extract metadata from the message. The metadata may include account information, authentication information, or preferences of the user for the PMC. Extracting the metadata from the message may include processing the message using a natural language processor. The metadata may include semantic information from the message.

A preparing module 312 may prepare the message for archiving, including converting the message to an archival format. The preparing module 312 may perform various tasks necessary to prepare the message for archiving.

An appending module 314 may append the message to a conversation container comprising associated other messages. A container may include various messages associated for various predetermined reasons (e.g., regarding a similar topic, event, or between the same parties).

The message may be marked for archiving and received at the processor as part of a batch of messages marked for archiving. The marking for archiving may be based on the message containing a designated character or string of characters.

An archiving module 316 may archive the message and the metadata on an electronic data storage unit (e.g., an electronic data storage unit 326). The archiving module 316 may archive the message and the metadata by storing the message and the metadata on the electronic data storage unit. The message and the metadata may be stored on the electronic data storage unit in a searchable form. Archiving may further include authenticating the user, preparing the message for archiving, including converting the message to an archival format, and creating a user data structure for the message on the user device to reflect a server data structure on the archiving server.

The archival format may be, for example, a portable document format, a text format, or a JavaScript object notation format. A report of archived messages may be generated. An archived record of the message may be provided to, for example, a third-party customer relationship management system. A status report may be provided to an administrator indicating a success or failure of archiving the message.

A contextual scanning module 318 may contextually scan the message to determine whether the message should be flagged for further attention.

A remote configuration module 320 may remotely configure the client archiving application.

A message deletion module 322 may delete the message based on a predefined message selection criteria or a search query. The search query may be based on a received input or the search query may be based on a compliance requirement.

The archiving may be performed at the conclusion of a predefined time period, after a predefined quantity of messages have been received by the processor, or at a predefined scheduled time.

A searching module 324 may perform a search. The search may include receiving, from an administration device, a search query. The search query may be based on the conversation container, the user, or contact information of the user. The search may then include searching the archived messages stored on the electronic data storage unit using the search query. One or more messages may be accessed, exported, or deleted, as well as associated metadata, based on the search query.

Various of the modules 308, 310, 312, 314, 316, 318, 320, 322, or 324 may be initiated by the PMC interface and may be executed using the processor silently without providing a notification to the user.

In some embodiments, the computing platform(s) 302, the remote platform(s) 304, and/or the external resources 330 may be operatively linked via one or more electronic communication links. For example, such electronic communication links may be established, at least in part, via a network such as the Internet and/or other networks using, for example, TCP/IP or cellular hardware enabling wired or wireless communication. It will be appreciated that this is not intended to be limiting, and that the scope of this disclosure includes embodiments in which the computing platform(s) 302, the remote platform(s) 304, and/or the external resources 330 may be operatively linked via some other communication media.

A given remote platform 304 may include one or more processors, which may be similar to, for example, the processing device 206 or the processing device 212, which may execute computer program modules. The computer program modules may enable an expert or user associated with the given remote platform 304 to interface with the system 300 and/or the external resources 330, and/or provide other functionality attributed herein to the remote platform(s) 304. For example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

The external resources 330 may include sources of information outside of the system 300, external entities participating with the system 300, and/or other resources. In some embodiments, some or all of the functionality attributed herein to the external resources 330 may be provided by resources included in the system 300.

The computing platform(s) 302 may include the electronic storage 326, one or more processors 328, which may be similar to, for example, the processing device 206 or the processing device 212, and/or other components. The computing platform(s) 302 may include communication lines, or ports to enable the exchange of information with a network and/or other computing platforms. Illustration of the computing platform(s) 302 in FIG. 3 is not intended to be limiting. The computing platform(s) 302 may include a plurality of hardware, software, and/or firmware components operating together to provide the functionality attributed herein to the computing platform(s) 302. For example, the computing platform(s) 302 may be implemented by a cloud of computing platforms operating together as the computing platform(s) 302.

The electronic storage 326 may comprise non-transitory storage media that electronically stores information and may be similar to the memory device 204 or the memory device 210. The electronic storage media of the electronic storage 326 may include one or both of system storage that is provided integrally (i.e., substantially non-removable) with the computing platform(s) 302 and/or removable storage that is removably connectable to the computing platform(s) 302 via, for example, a port (e.g., a USB port, a firewire port, etc.) or a drive (e.g., a disk drive, etc.). The electronic storage 326 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 326 may include one or more virtual storage resources (e.g., cloud storage, a virtual private network, and/or other virtual storage resources). The electronic storage 326 may store software algorithms, information determined by the processor(s) 328, information received from the computing platform(s) 302, information received from the remote platform(s) 304, and/or other information that enables the computing platform(s) 302 to function as described herein.

The processor(s) 328 may provide information processing capabilities in the computing platform(s) 302. As such, the processor(s) 328 may include one or more of a digital processor, an analog processor, a digital circuit designed to process information, an analog circuit designed to process information, a state machine, and/or other mechanisms for electronically processing information. Although the processor(s) 328 is shown in FIG. 3 as a single entity, this is for illustrative purposes only. In some embodiments, the processor(s) 328 may include a plurality of processing units. These processing units may be physically located within the same device, or the processor(s) 328 may represent processing functionality of a plurality of devices operating in coordination. The processor(s) 328 may execute the modules 308, 310, 312, 314, 316, 318, 320, 322, or 324, and/or other modules. The processor(s) 328 may execute the modules 308, 310, 312, 314, 316, 318, 320, 322, or 324, and/or other modules by software; hardware; firmware; some combination of software, hardware, and/or firmware; and/or other mechanisms for configuring processing capabilities on the processor(s) 328. As used herein, the term “module” may refer to any component or set of components that perform the functionality attributed to the module. This may include one or more physical processors during execution of processor readable instructions, the processor readable instructions, circuitry, hardware, storage media, or any other components. Various modules or portions thereof may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), Streaming SIMD Extension (SSE), or other technologies or methodologies, as desired.

It should be appreciated that although the modules 308, 310, 312, 314, 316, 318, 320, 322, or 324 are illustrated in FIG. 3 as being implemented within a single processing unit, in embodiments in which the processor(s) 328 includes multiple processing units, one or more of the modules 308, 310, 312, 314, 316, 318, 320, 322, or 324 may be implemented remotely from the other modules. The description of the functionality provided by the different modules 308, 310, 312, 314, 316, 318, 320, 322, or 324 described below is for illustrative purposes, and is not intended to be limiting, as any of the modules 308, 310, 312, 314, 316, 318, 320, 322, or 324 may provide more or less functionality than is described. For example, one or more of the modules 308, 310, 312, 314, 316, 318, 320, 322, or 324 may be eliminated, and some or all of its functionality may be provided by other ones of the modules 308, 310, 312, 314, and 316. As another example, the processor(s) 328 may execute one or more additional modules that may perform some or all of the functionality attributed below to one of the modules 308, 310, 312, 314, and 316.

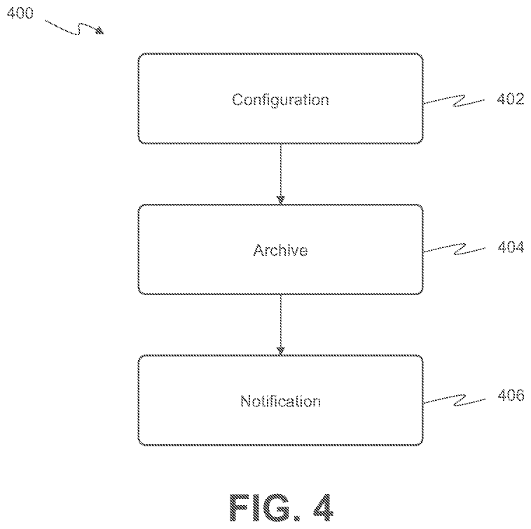

FIG. 4 illustrates a method 400 of operating a communications surveillance platform, according to an embodiment. The method 400 may provide for performance of embodiments of communications surveillance platforms as described herein.

An operation 402 may include configuring a communications surveillance platform. The operation 402 may be performed by one or more hardware processors configured by machine-readable instructions including a module that is the same as or similar to various of the modules, in accordance with one or more embodiments.

The operation 402 may capture various inputs from a user to enable an archiving of messages (e.g., SMS, MMS messages, or messages from over-the-top data (OTT) services such as WhatsApp and WeChat, or social media platforms). For example, the operation 402 may capture a user's account information (e.g., a username and a password) and archiving preferences from the user. In one embodiment, the archiving preferences may specify an archiving schedule comprising archiving events. During each archiving event, the client archiving application may transmit the messages to be archived to the remote archiving application. The schedule may include a frequency (e.g., a predetermined time period) with for the archiving events and a time of day at which to perform the archiving events. In one embodiment, the archiving schedule may be specified in terms of a predefined volumes (e.g., quantity) of messages marked for archiving that must be accumulated before an archiving event occurs. In this embodiment, the messages marked for archiving may be sent in a message batch comprising all the messages marked for archiving since the last archiving event.

The archiving preferences may include a specification of, for example, a special archiving character(s) or string(s) in a message subject that may denote to the computing platform 302 that a message is to be included for archival or to be excluded. For example, a pound sign (e.g., “#”) in a message subject or in a message body at a designated location (e.g., at the beginning) may mark a message for inclusion or exclusion in the next archiving event.

The archiving character may indicate a preference for the message or recent messages to be archived into a particular system of choice or format of choice. For example, archiving characters in the form of the string “#deal” may indicate that the most recent messages involved a negotiation that should be, for example, archived to an appropriate sales or customer relationship management (CRM) system that hold sales data.

A user may select particular conversations to be archived based on various criteria. For example, messages or conversations may be archived based on a selection of recipients or participants from a list of conversations. The selection may be based on selection of contact metadata associated with a contact such as, for example, a contact's name, address, or selection of phone numbers or email.

A message may be annotated with a special character(s) to indicate that the message is to be archived. This is particularly useful in cases where a message lacks an archiving character(s) and yet is to be archived.

A decision about which conversations are archived may be made based on the business relationship information from external data sources. This may be accomplished by obtaining a list of a business's contacts from a list made available locally, or by an internet service, such as a REST API, to the device. The list may contain, for example, first and last names, phone numbers, emails or address information. The business relationship information may include information about the state of business dealings with a contact, such as a lead, account, sale or other similar customer relationship information. The list of information described above may be matched against the information available on the phone such as the phone number and name, in order to decide which text messaging sessions may have business relevance and are thus marked for archiving.

Archival of a particular conversation may be to a particular backup location based on a conversation annotation. The conversation annotation may correspond to a business or consumer service location remote to the messaging device.

Information associated with a message may be identified and treated as an annotation based on, for example, natural language processing to detect semantic information such as, inter alia, a scheduled event, meeting, conference, or deal.

The PMC interface may contextually scan the text of the messages in order to determine if a particular message warrants further attention. The scan may look for interesting words in the text, which may imply, inter alia, locations, dates, times, dollar amounts, names, technical terms, or product information. The PMC interface may assemble a list of such possible interesting events such that a user may then choose an activity to perform. The activities may take a tranche of information and back up the data to a particular third-party data storage location, such as a CRM system or other similar system.

A data format of archived messages may include at least a conversation container, which may include the parties involved (e.g., receivers and senders). In terms of message data, there may be text or binary data, including multimedia information such as pictures or videos. Messages and message metadata may also include, inter alia, a date, time, send state information, and location information.

An operation 404 may include performing an archiving operation. The operation 404 may be performed by one or more hardware processors configured by machine-readable instructions including a module that is the same as or similar to various of the modules, in accordance with one or more embodiments.

The operation 404 may include encrypting messages since a prior archiving event and transmitting the encrypted messages to, for example, the computing platform 302. The operation 404 may also include transmitting message sender and recipient information associated with each message, as well as the time of that each message was sent or received. An entire message conversation may be transmitted for archiving by the personal message channel interface.

An operation 406 may include performing a notification operation. The operation 406 may be performed by one or more hardware processors configured by machine-readable instructions including a module that is the same as or similar to various of the modules, in accordance with one or more embodiments. Periodic notifications in the form of a status report may be provided to a user and/or an administrator to indicate a success or failure of the last performed archiving operation.

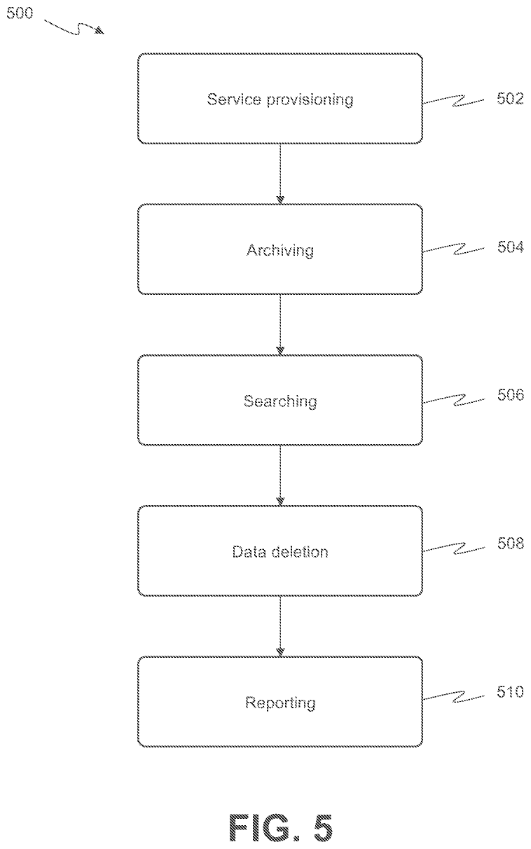

FIG. 5 illustrates a method 500 of operating a communications surveillance platform, according to an embodiment. The method 500 may provide for performance of embodiments of communications surveillance platforms as described herein.

An operation 502 may include service provisioning. The operation 502 may be performed by one or more hardware processors configured by machine-readable instructions including a module that is the same as or similar to various of the modules, in accordance with one or more embodiments.

A user account may be created to facilitate archiving and service provisioning information is configured. Service provisioning information may include, for example, the internet location of a relay pipeline, direct data store locations for media, REST API service locations, encryption requirements around stored data, requirements of a company to backup all data versus the employee choosing which conversations to backup, any encryption key or other similar information as required by data privacy law or legal agreement, the location of the archiving servers over an internet protocol (IP) network, and any credentials required to access the archiving location and upload data to the archiving location. The service provisioning information may enable multimodal archiving designed to use a standardized transport container format such as extensible markup language (XML), JavaScript Object Notation (JSON), or encrypted JSON to carry the data to various network destinations and systems.

An operation 504 may include archiving one or more messages and associated metadata. The operation 504 may be performed by one or more hardware processors configured by machine-readable instructions including a module that is the same as or similar to various of the modules, in accordance with one or more embodiments.

The archiving operation 504 may include receiving an archiving request from the user device (e.g., via a PMC interface). The archiving operation 504 may authenticate the user. Messages received from the PMC interface may be prepared for archiving, which may include formatting the messages (e.g., into portable document format (PDF), JSON, or another format). Thereafter, the messages may be stored in memory an associated with the user's account.

Corresponding data structures may be created in a local data store on the messaging device. Such data structures may be identical or similar to those on the archiving server and may include the conversation and corresponding message/conversation data.

The PMC interface may monitor new conversations across multiple messaging services. When a new conversation is detected, the PMC interface may use a standard string or pattern matching algorithm to determine if the parties involved in the new conversation match the parties in an earlier conversation. A unified view of conversations between the same parties across multiple messaging services may thus be presented. Data used for matching may include metadata related to the contact, such as, for example, phone numbers, email, or address data for the contact, such that a contact from one service may be matched based on the phone number, email or any other available information to the same contact in a messaging service.

An attempt may be made also, by comparing the same information, to correlate any conversations from one message storage provider (such as an SMS message or an end-to-end message) with another (such as an OTT message).

The messages may be stored in any number of formats, including as in a file-based storage format, in an incremental storage container, in a database, or in other similar storage structure, such as, for example, a JSON document-based NoSQL storage server, or relational datastore.

In the case where the SMS message is stored to a file system, data may be secured (e.g., committed) such that the dates, times and recipients associated with the message cannot be altered after the data has been uploaded from the messaging device.

Dates and recipients of the messages may be used along with a private key to generate a checksum or may be separately encrypted such that the decryption of that data will match the unencrypted stored data. Encrypted data may be decrypted using a key available to the archiving server and the messaging device itself that holds a private encryption key.

An operation 506 may include performing a search. The operation 506 may be performed by one or more hardware processors configured by machine-readable instructions including a module that is the same as or similar to various of the modules, in accordance with one or more embodiments.

The operation 506 may locate particular messages based on a search query initiated by the user. The search may be performed on an archival server or on a messaging device (e.g., a user device). The operation 506 may allow a user to locate and identify messages to the user as backed up from one or multiple message services.

Messages may be searched based on the content or metadata of the messages, including conversation containers or users involved, and their contact information such as, for example, phone numbers emails, or addresses.

A search may comprise the search of any multimedia data that may be attached to a message. A multimedia data search may involve extracting any recorded audio information first, creating a transcript to be available in a text record. The search may then include a textual search of the transcript in addition to any content that is purely text.

An operation 508 may include deleting one or more messages. The operation 508 may be performed by one or more hardware processors configured by machine-readable instructions including a module that is the same as or similar to various of the modules, in accordance with one or more embodiments. Messages may be deleted based on, for example, certain predefined message deletion criteria (e.g., messages older than a defined age) or a search/search query. Deletion criteria may also be based on compliance requirements set by, for example, legislation or an industry regulator or governance body.

An operation 510 may include reporting on messages stored by the system. The operation 510 may be performed by one or more hardware processors configured by machine-readable instructions including a module that is the same as or similar to various of the modules, in accordance with one or more embodiments.

The operations of the methods 400 and 500 presented herein are intended to be illustrative. In some embodiments, the methods 400 and 500 may be accomplished with one or more additional operations not described, and/or without one or more of the operations discussed. Additionally, the order in which the operations of the methods 400 or 500 are illustrated in the drawings and described herein is not intended to be limiting.

In some embodiments, the methods 400 or 500 may be implemented in one or more processing devices (e.g., a digital processor, an analog processor, a digital circuit designed to process information, an analog circuit designed to process information, a state machine, and/or other mechanisms for electronically processing information), which may be similar to, for example, the processing device 206, the processing device 212, or the processor 328. The one or more processing devices may include one or more devices executing some or all of the operations of method 400 in response to instructions stored electronically on an electronic storage medium, which may be similar to the memory device 204, the memory device 210, or the electronic storage 326. The one or more processing devices may include one or more devices configured through hardware, firmware, and/or software to be specifically designed for execution of one or more of the operations of method 400.

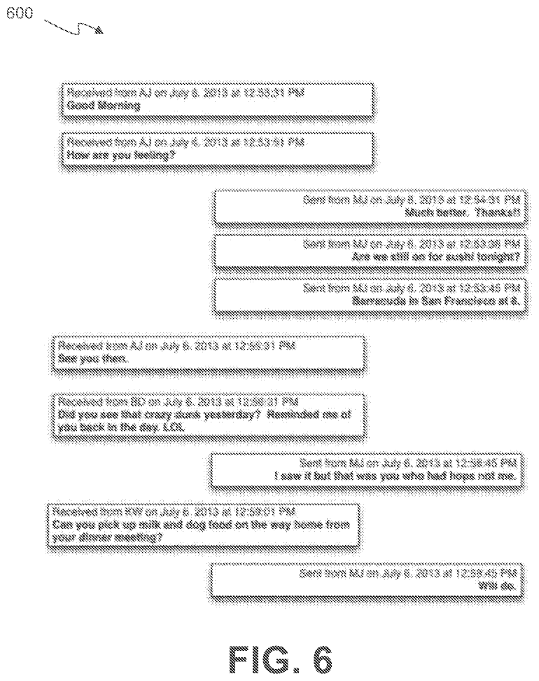

FIG. 6 illustrates an example report 600, according to an embodiment. The report 600 may provide insights as to communications archived by the system for various purposes ranging from business recordkeeping to litigation evidentiary production.

The report 600 may provide, for example, an exchange of messages between a user and another party. The report 600 may include messages in a conversation-like format, and each message may include the content of the message, as well as metadata regarding the message. Such message metadata may include, for example, the sender of the message, the recipient of the message, and the date and time the message was sent or received. A report such as the report 600 may be delivered to the requester, for example, via email.

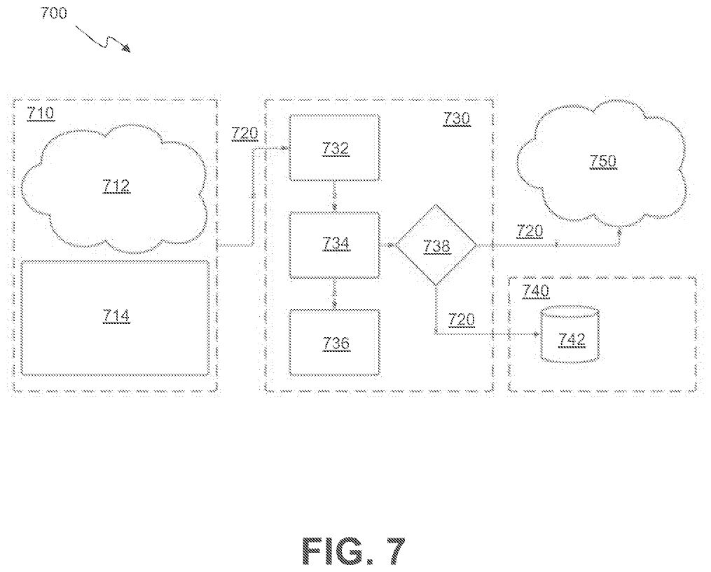

FIG. 7 illustrates an example system 700, according to an embodiment. The example system may provide for capturing and securely transporting peer-to-peer communications to adhere to global communications compliance regulations and privacy laws.

External messaging services or PMCs 710 may include cloud-based external messaging services 712 (e.g., TWITTER®, WHATSAPP®, FACEBOOK®, WECHAT®/WECOM®, or any other service that and externally stores and persists messages for historical retrieval upon login on multiple devices) and ephemeral and device systems 714 (e.g., ANDROID® SMS/MMS, IMESSAGE®, or any other service that does not persist messages and depends on the receiving platform to retain it). Communication (e.g., interprocess and intersystem communications) over electronic communication links 720 may implement TLS encryption (e.g., TLS 1.2 encryption).

The communications surveillance platform 730 may include a collector 732, a dispatcher 734, a message router 736, and an encrypted logger 738. The collector 732 may collect and convert messages from disparate platforms into a standard internal format, which may be passed to the dispatcher 734. The dispatcher 734 may distribute messages via the message router 736 and determine whether to route to an archival platform 740, an external archival platform, or both, and route the messages appropriately. The encrypted logger 738 may log messages using a known one-way hash algorithm such that the messages cannot be unencrypted. The encrypted logger 738 may apply the hash algorithm to a message externally before intake at the collector or after a push to an archival system would result in the same hash, thus enabling an establishment of provenance and proof of the validity of messages that have entered the system. The encryption methods may also be used to establish the veracity of a foreign messaging system in the case of potential tampering.

A database 742 of the archival platform 740 may receive data encrypted in such a way that decryption keys can only be retrieved and used on the data upon a successful login using client credentials. Data may be “at rest” in the database 742, but securely encrypted until accessed with an encryption key. Data may be further transferred to an external archival system 750, and may be encrypted in route, for example, using TLS (e.g., TLS 1.2 encryption).

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A method, comprising:
receiving, at a processor of an archiving server running a remote archiving application, via a network interface, a message, wherein:
the message is generated from a user device;
the network interface operates via a network connection;
the message was communicated using a private messaging channel operating on the user device;
the private messaging channel is monitored by a private messaging channel interface of a client archiving application configured to send the message to the processor via the network interface;
the message was sent or received by a user of the user device; and
the message is a short message system message, a multimedia message system message, an end-to-end message, an over-the-top message, a social media direct message, a non-text binary payload, or a non-alphanumeric character-based message;
extracting, using the processor, metadata from the message;
preparing, using the processor, the message for archiving, including converting the message to an archival format;
appending, using the processor, the message to a conversation container comprising associated other messages;
archiving, using the processor, the message and the metadata on an electronic data storage unit by storing the message and the metadata on the electronic data storage unit, wherein the message and the metadata are stored on the electronic data storage unit in a searchable format; and
wherein the receiving, extracting, and archiving are initiated by the private messaging channel interface and executed using the processor silently without providing a notification to the user.

2. The method of claim 1, wherein
the archiving is performed at the conclusion of a predefined time period;
the archiving is performed after a predefined quantity of messages have been received by the processor; or
the archiving is performed at a predefined scheduled time.

3. The method of claim 1, wherein the metadata includes account information, authentication information, or preferences of the user for the private messaging channel.

4. The method of claim 1, wherein the message is marked for archiving and received at the processor as part of a batch of messages marked for archiving.

5. The method of claim 4, wherein the marking for archiving is based on the message containing a designated character or string of characters.

6. The method of claim 1, further comprising, using the processor, contextually scanning the message to determine whether the message should be flagged for further attention.

7. The method of claim 1, further comprising remotely configuring, using the processor, the client archiving application.

8. The method of claim 1, wherein extracting the metadata from the message includes processing the message using a natural language processor and the metadata includes semantic information from the message.

9. The method of claim 1, further comprising deleting the message based on:
a predefined message selection criteria; or
a search query, wherein:
the search query is based on a received input; or
the search query is based on a compliance requirement.

10. A system, comprising:
an archiving server, comprising
an electronic data storage unit configured to store an archive of messages;
a network interface in operative communication over a network connection;
a processor in operative communication with the network interface and the electronic data storage unit, wherein the processor is configured to:
receive a message from a user device via the network interface, wherein:
the message was communicated using a private messaging channel operating on the user device;
the private messaging channel is monitored by a private messaging channel interface of a client archiving application configured to send the message to the processor via the network interface;
the message was sent or received by a user of the user device; and
the message is a short message system message, a multimedia message system message, an end-to-end message, an over-the-top message, or a social media direct message.
archive the message, comprising:
converting the message to an archival format;
extracting metadata from the message; and
storing the message and the metadata on the electronic data storage unit.

11. The system of claim 10, wherein:
the message is encrypted by the private messaging channel interface into an encrypted message format;
the message is received at the processor in the encrypted message format; and
the remote archiving application is configured to decrypt the message from the encrypted message format.

12. The system of claim 10, wherein the device is a registered device, comprising:
an account for the device;
provisioning for the account, comprising a configuration of:
an internet location of a relay pipeline;
direct data store locations for media contained in messages;
REST API service locations;
encryption requirements around stored data;
backup requirements and options;
encryption keys;
information required by a data privacy law or a legal agreement;
a location of the archiving servers over an internet protocol network; and
credentials required to access the archiving server and upload data to the archiving server.

13. A method, comprising:
receiving, at a processor of an archiving server running a remote archiving application, via a network interface, a message, wherein:
the message was communicated using a private messaging channel operating on a user device;
the private messaging channel is monitored by a private messaging channel interface of a client archiving application configured to send the message to the processor via the network interface;
the message was sent or received by a user of the user device; and
the message is a short message system message, a multimedia message system message, an end-to-end message, an over-the-top message, or a social media direct message.
archiving, using the processor, the message on an electronic data storage unit by storing the message on the electronic data storage unit, wherein the message is stored on the electronic data storage unit in a searchable format.

14. The method of claim 13, further comprising:
receiving, at the processor, from an administration device, a search query, the search query being based on the conversation container, the user, or contact information of the user; and
searching, using the processor, the archived messages stored on the electronic data storage unit using the search query.

15. The method of claim 14, further comprising deleting the message and its associated metadata based on the search query.

16. The method of claim 13, wherein the archiving further comprises:
authenticating the user;
preparing the message for archiving, including converting the message to an archival format; and
creating a user data structure for the message on the user device to reflect a server data structure on the archiving server.

17. The method of claim 16, wherein the archival format is a portable document format, a text format, or a JavaScript object notation format.

18. The method of claim 13, further comprising generating a report of archived messages.

19. The method of claim 13, further comprising providing the archived record of the message to a third-party customer relationship management system.

20. The method of claim 13, further comprising providing a status report to an administrator indicating a success or failure of archiving the message.
